(19) United States
(12) Patent Application Publication
(10) Pub. No.: US 2025/0167288 A1
(43) Pub. Date: May 22, 2025

(54) LITHIUM ION BATTERY

(71) Applicant: TOYOTA JIDOSHA KABUSHIKI KAISHA, Toyota-shi (JP)

(72) Inventor: Masaharu Senoue, Seto-shi (JP)

(73) Assignee: TOYOTA JIDOSHA KABUSHIKI KAISHA, Toyota-shi (JP)

(21) Appl. No.: 18/938,658

(22) Filed: Nov. 6, 2024

(30) Foreign Application Priority Data
Nov. 17, 2023 (JP) 2023-195771

(51) Int. Cl. H01M 10/0525; H01M 4/02; H01M 4/36; H01M 4/38; H01M 4/583

(52) U.S. Cl. CPC H01M 10/0525; H01M 4/366; H01M 4/386; H01M 4/583; H01M 2004/027; H01M 2004/028

(57) ABSTRACT

The lithium ion battery includes a positive electrode active material layer, a negative electrode active material layer, and an electrolytic solution. The negative electrode active material layer includes a first region and a second region. The first region and the second region are alternately arranged in a direction orthogonal to the thickness direction of the negative electrode active material layer. The negative electrode active material layer includes a first active material and a second active material. The second active material has a larger specific capacity than the first active material. The relation between “T2<T1” and “R1<R2” is satisfied. T1 indicates the thickness of the first region during discharging. T2 indicates the thickness of the second region during discharging. R1 indicates a ratio of the mass of the second active material to the total mass of the first active material and the second active material.

### CROSS-REFERENCE TO RELATED APPLICATION

This application claims priority to Japanese Patent Application No. 2023-filed on Nov. 17, 2023, incorporated herein by reference in its entirety.

### BACKGROUND

### 1. Technical Field

The present disclosure relates to a lithium ion battery.

### 2. Description of Related Art

Japanese Unexamined Patent Application Publication No. 2019-192338 (JP 2019-192338 A) discloses an all-solid-state battery in which at least one of a positive electrode surface and a negative electrode surface has a slit-shaped groove.

### SUMMARY

When a lithium ion battery (which may hereinafter be abbreviated as “battery”) is manufactured, an electrolytic solution is impregnated into a power storage element. When the electrolytic solution is insufficiently impregnated and the electrolytic solution is not spread throughout, the discharge capacity may be lower than the design capacity.

In general, a means for increasing the basis weight of an active material layer (which will hereinafter be referred to also as “first means”) or a means for increasing the area of an active material layer (which will hereinafter be referred to also as “second means”) can be considered as a means for increasing the capacity. The first means tends to have many disadvantages, such as difficulty in impregnating the electrolytic solution and increase in resistance. Therefore, the second means tends to be selected conventionally. When the power storage element has a bipolar structure, however, it is often necessary to select the first means. This is because in the case of a bipolar structure, the battery voltage depends on the number of stacked electrodes. In the second means, the number of stacked electrodes also increases. In order to achieve a desired battery voltage, the second means often cannot be selected.

In the first means, the active material layer becomes thicker. As the active material layer becomes thicker, the time required to impregnate the electrolytic solution (hereinafter also referred to as “impregnation time”) tends to be longer. In order to shorten the impregnation time, it is conceivable to provide a groove in the active material layer. When the groove forms a flow path for the electrolytic solution, it is expected to shorten the impregnation time. Normally, it is considered appropriate to provide the groove in the positive electrode active material layer. When the groove is provided in the negative electrode active material layer, lithium (Li) ions are concentrated at the edge of the groove during charging, and Li may be deposited. In general, however, the positive electrode active material layer is the source of the capacity. Before initial charging, the positive electrode active material layer contains Li. If the groove is provided in the positive electrode active material layer, the volume of the positive electrode active material layer is reduced. As a result, the design capacity is reduced.

An object of the present disclosure is to reduce the impregnation time.

1. One aspect of the present disclosure provides a lithium ion battery that includes the following configuration.

A lithium ion battery including
a positive electrode active material layer, a negative electrode active material layer, and an electrolytic solution.
   The negative electrode active material layer includes a first region and a second region.
   The first region and the second region are arranged alternately in a direction orthogonal to a thickness direction of the negative electrode active material layer.
   The negative electrode active material layer contains a first active material and a second active material.
   The second active material has a larger specific capacity than the first active material. Relationships of following formula (1) and formula (2) are met:

$$T 2 < T 1 \qquad ( 1 )$$

$$R 1 < R 2 \qquad ( 2 )$$

In the formula (1),
T1 indicates a thickness of the first region during discharging, and
T2 indicates a thickness of the second region during discharging.
   In the formula (2),
R1 indicates a ratio of a mass of the second active material to a total mass of the first active material and the second active material in the first region, and
R2 indicates a ratio of a mass of the second active material to a total mass of the first active material and the second active material in the second region.

The negative electrode active material layer includes a first region and a second region. The second region is thinner than the first region. There is a step between a surface of the second region and a surface of the first region. That is, the second region is the bottom wall of a groove. The negative electrode active material layer contains a first active material and a second active material. The second active material is a high-capacity active material. The ratio of the high-capacity active material is higher in the second region (bottom wall of the groove) than in the first region. Thus, Li receptivity in the groove may be locally improved compared to the surrounding region. That is, Li deposition may be reduced. When the groove is formed, further, it is expected to shorten the impregnation time. When the groove is provided in the negative electrode active material layer, reduction of the positive electrode active material layer can be avoided.

2. The lithium ion battery according to 1 above may include the following configuration, for example. At least one of relationships of following formula (3) and formula (4) is further met:

$$T 2 / T 1 \leq 0.4 \qquad ( 3 )$$

$${T}_{0} 2 / {T}_{0} 1 \leq 0.3 \qquad ( 4 )$$

In the formula (4),
T₀1 indicates a thickness of the first region before initial charging, and
T₀2 indicates a thickness of the second region before initial charging.

When at least one of the relationships of the formula (3) and formula (4) is met, it is expected to shorten the impregnation time. The thickness of the negative electrode active material layer increases during charging and decreases during discharging. After initial charging, however, the thickness during discharging does not recover to the thickness before initial charging. That is, the relationships “T₀1<T1” and “T₀2<T2” are normally met.

3. The lithium ion battery according to 2 above may include the following configuration, for example. At least one of relationships of following formula (5) and formula (6) is further met:

$$130 μm \leq T 1 \qquad ( 5 )$$

$$100 μm \leq {T}_{0} 1 \qquad ( 6 )$$

Conventionally, when at least one of the relationships of the formula (5) and formula (6) is met, the impregnation time increases remarkably. In the battery according to “1” above, it is expected to shorten the impregnation time also when at least one of the relationships of the formula (5) and formula (6) is met.

4. The lithium ion battery according to any one of 1 to 3 above may include the following configuration, for example.

The first active material contains graphite.
The second active material contains at least one kind selected from the group consisting of silicon, silicon oxide, and a silicon-carbon composite material.

Silicon (Si), silicon oxide (SiO), and a silicon-carbon composite material (Si—C) may have a larger specific capacity than graphite.

5. One aspect of the present disclosure provides a lithium ion battery that may include the following configuration. A lithium ion battery including a positive electrode active material layer, a negative electrode active material layer, and an electrolytic solution.

The negative electrode active material layer includes a first region and a second region.
The first region and the second region are arranged alternately in a direction orthogonal to a thickness direction of the negative electrode active material layer.
The negative electrode active material layer contains a first active material and a second active material.
The second active material has a larger specific capacity than the first active material.
The first active material contains graphite.
The second active material contains at least one kind selected from the group consisting of silicon, silicon oxide, and a silicon-carbon composite material.
Relationships of the above formula (1) and formula (2) are met.
At least one of relationships of the above formula (3) and formula (4) is met.
At least one of relationships of the above formula (5) and formula (6) is further met.

Hereinafter, an embodiment of the present disclosure (which may hereinafter be abbreviated as “present embodiment”) and an example of the present disclosure (which may hereinafter be abbreviated as “present example”) will be described. However, the present embodiment and the present example do not limit the technical scope of the present disclosure. The present embodiment and the present example are illustrative in all respects. The present embodiment and the present example are not restrictive. The technical scope of the present disclosure includes all changes that fall within the meaning and scope equivalent to the claims. For example, it is originally planned to extract appropriate configurations from the present embodiment and combine such configurations as appropriate.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a conceptual diagram illustrating an example of a lithium ion battery according to the present embodiment;

FIG. 2 is a schematic plan view illustrating an example of a negative electrode active material layer according to the present embodiment;

FIG. 3 is a table showing experimental conditions; and

FIG. 4 is a table showing experimental results.

### DETAILED DESCRIPTION OF EMBODIMENTS

### Main Terms

“Specific capacity (unit: mAh/g)” indicates discharge capacity per unit mass. The specific capacity is measured by a unipolar test.

Geometric terms (e.g., parallel, vertical, orthogonal, etc.) should not be taken in a strict sense. For example, “parallel” may deviate somewhat from “parallel” in a strict sense. The geometric terms may include, for example, design, work, or manufacturing tolerances or variations. Dimensional relationships in each drawing may not match actual dimensional relationships. The dimensional relationships in each drawing may be changed to facilitate understanding of readers. For example, the length, width, and thickness may be changed. Some configurations may be omitted.

“Discharged” indicates a condition in which state of charge (SOC) is 0%. “SOC” indicates the percentage of discharged electricity excluding the percentage of discharged electricity from the condition in which the batteries are fully charged. SOC may also be referred to as “charge-level.”

“Silicon-carbon composite (Si—C)” refers to a composite comprising Si and C. Si—C may comprise, for example, composites. For example, Si may be supported by a carbon-based material to form a composite-particle. The carbon material may be, for example, crystalline or amorphous.

A “plan view” indicates viewing an object with a line of sight parallel to a thickness direction of the object. The shape of the object in a plan view is shown in a plan view.

Numerical ranges such as “m % to n %” include upper and lower limits unless otherwise specified. “m % to n %” indicates a numerical range of “m % or more and n % or less”. “m % or more and n % or less” includes “more than m % and less than n %”. The terms “greater than or equal to” and “less than or equal to” are represented by an equal sign inequality sign “≤”. The terms “greater than” and “less than” are represented by inequality signs “<” that do not include equal signs.

“D50” refers to the particle size at which the integration is 50% in the volume-based particle size distribution (integrated distribution). The particle size distribution can be measured by laser diffraction methods.

### Lithium Ion Battery

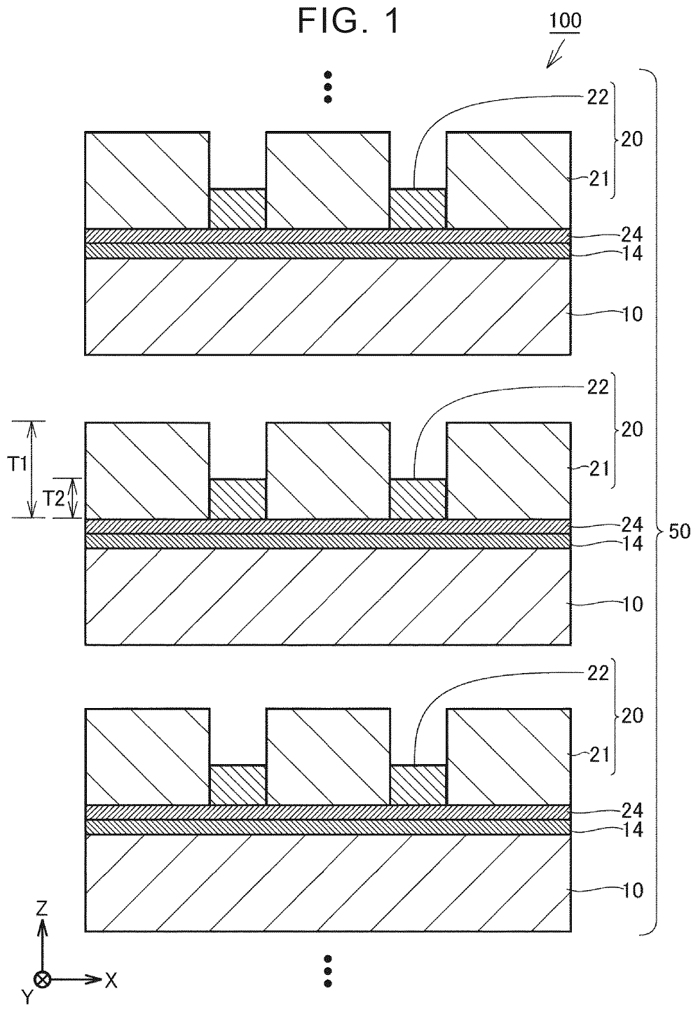

FIG. 1 is a conceptual diagram illustrating an example of a lithium ion battery according to the present embodiment. The battery 100 includes a power storage element 50 and an electrolytic solution (not shown). The battery 100 may include an exterior body (not shown). The exterior body may contain the power storage element 50 and the electrolytic solution. The sheath may have any form. The exterior body may include, for example, a metal case, a pouch made of a metal foil laminate film, and the like.

### Storage Element

The power storage element 50 may be referred to as, for example, an “electrode assembly”, an “electrode group”, or the like. The power storage element 50 may have, for example, a monopolar structure. The power storage element 50 may be, for example, a wound type. The power storage element 50 may have, for example, a bipolar structure. The power storage element 50 may be, for example, a stacked type.

The power storage element 50 in FIG. 1 has a bipolar structure as an example. The power storage element 50 may include, for example, a positive electrode current collector 14, a positive electrode active material layer 10, a negative electrode active material layer 20, and a negative electrode current collector 24. For example, the positive electrode current collector 14 may be attached to the negative electrode current collector 24 by a conductive adhesive (not shown). The power storage element 50 may include a plurality of positive electrode active material layers 10 and a plurality of negative electrode active material layers 20.

### Negative Electrode Active Material Layer

The negative electrode active material layer 20 may be supported by the negative electrode current collector 24, for example. The negative electrode current collector 24 may include, for example, copper (Cu), nickel (Ni), or a conductive resin. The negative electrode current collector 24 may include, for example, a Cu foil, a Cu alloy foil, or the like. The thickness of the negative electrode current collector 24 may be, for example, 5 to 50 μm. A conductive layer may be interposed between the negative electrode current collector 24 and the negative electrode active material layer 20. The conductive layer may include, for example, metal particles, carbon particles, and the like.

The negative electrode active material layer 20 includes a first region 21 and a second region 22. The first region 21 and the second region 22 have different thicknesses and compositions. The first region 21 and the second region 22 are alternately arranged in a direction (in-plane direction) orthogonal to the thickness direction of the negative electrode active material layer 20. In FIG. 1, the Z direction is the thickness direction. The X direction and the Y direction are examples of in-plane directions. The in-plane direction is an arbitrary direction as long as it is orthogonal to the thickness direction.

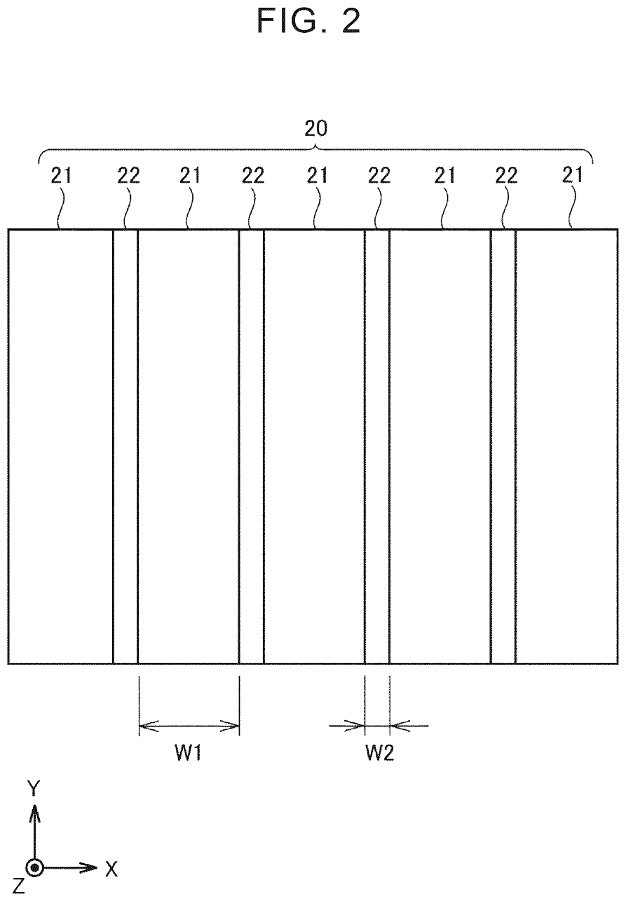

FIG. 2 is a schematic plan view illustrating an example of a negative electrode active material layer according to the present embodiment. The arrangement of the first region 21 and the second region 22 may be regular or random. The planar shape of the second region 22 is arbitrary. In plan view, the second region 22 may extend in a linear shape, for example. The second region 22 may extend linearly, for example. The second region 22 may have, for example, a stripe shape. The second region 22 may extend in a lattice shape, for example. The second region 22 may extend across the negative electrode active material layer 20. The second region 22 may not cross the negative electrode active material layer 20. The second region 22 may be scattered in a dotted pattern, for example.

In plan view, the width (W2) of the second region 22 may be smaller than the width (W1) of the first region 21. W2/W1 may be, for example, 0.90 or less, 0.80 or less, 0.70 or less, 0.60 or less, 0.50 or less, 0.40 or less, 0.30 or less, 0.20 or less, 0.10 or less, or 0.05 or less. W2/W1 may be, for example, 0.01 or more, 0.02 or more, 0.05 or more, or 0.10 or more. W1 may be, for example, 5 to 100 mm. W2 may be, for example, 1 to 3 mm. The area (S2) of the second region 22 may be smaller than the area (S1) of the first region 21. S2/S1 may be, for example, 0.90 or less, 0.80 or less, 0.70 or less, 0.60 or less, 0.50 or less, 0.40 or less, 0.30 or less, 0.20 or less, 0.10 or less, or 0.05 or less. S2/S1 may be, for example, 0.01 or more, 0.02 or more, 0.05 or more, or 0.10 or more.

As shown in FIG. 1, the second region 22 forms a groove. following formula (1) is satisfied.

$$T 2 < T 1 \qquad ( 1 )$$

T1: thickness of the first region 21 during discharging
T2: Thickness of the second region 22 during discharging

With respect to the thickness of each region, for example, following formula (3) may be satisfied.

$$T 2 / T 1 \leq 0.4 \qquad ( 3 )$$

The specific thickness (T2/T1) may be, for example, 0.55 or less, 0.50 or less, 0.45 or less, 0.35 or less, 0.30 or less, 0.25 or less, or 0.20 or less. The specific thickness (T2/T1) may be, for example, 0.10 or more, 0.15 or more, 0.20 or more, 0.25 or more, 0.30 or more, 0.35 or more, or 0.40 or more.

With respect to the thickness of each region, for example, following formula (4) may be satisfied.

$${T}_{0} 2 / {T}_{0} 1 \leq 0.3 \qquad ( 4 )$$

T₀1: Thickness of first region 21 prior to first charge
T₀2: Thickness of the second region 22 prior to the first charge
   The thickness ratio (T₀2/T₀1) may be, for example, 0.35 or less, 0.3 or less, 0.25 or less, 0.2 or less, 0.15 or less, 0.10 or less, or 0.05 or less. The thickness ratio (T₀2/T₀1) may be, for example, 0.01 or more, 0.05 or more, 0.10 or more, 0.15 or more, or 0.20 or more.

The thickness (T1) may be, for example, 10 μm or more, 50 μm or more, 100 μm or more, 150 μm or more, 200 μm or more, 250 μm or more, or 300 μm or more. For example, following formula (5) may be satisfied.

$$130 μ m \leq T 1 \qquad ( 5 )$$

The thickness (T1) may be, for example, 1000 μm or less, 500 μm or less, 300 μm or less, 250 μm or less, 200 μm or less, or 150 μm or less.

For example, the relation “T₀1<T1” may be satisfied. The thickness (T₀1) may be, for example, 10 μm or more, 50 μm or more, 150 μm or more, 200 μm or more, 250 m or more, or 300 μm or more. For example, following formula (6) may be satisfied.

$$100 μ m \leq {T}_{0} 1 \qquad ( 6 )$$

The thickness (T₀1) may be, for example, 1000 μm or less, 500 μm or less, 300 μm or less, 250 μm or less, 200 μm or less, or 150 μm or less.

The thickness (T2) may be, for example, 10 μm or more, 30 μm or more, 50 m or more, 75 μm or more, or 100 μm or more. The thickness (T2) may be, for example, 150 μm or less, 100 μm or less, or 75 μm or less. The thickness (T₀2) may be, for example, m or more, 10 μm or more, 20 μm or more, 30 μm or more, 40 μm or more, 50 μm or more, or 60 μm or more. The thickness (T₀2) may be, for example, 100 μm or less, 75 m or less, or 50 μm or less.

The negative electrode active material layer 20 includes a first active material and a second active material. The first active material may include, for example, at least one selected from the group consisting of graphite, soft carbon, hard carbon, and lithium titanate. The graphite may be natural graphite or artificial graphite. The first active material may have, for example, a larger D50 than the second active material. D50 of the first active material may be, for example, 10 to 25 μm. The second active material has a larger specific capacity than the first active material. The second active material may include, for example, at least one selected from the group consisting of Si, SiO, and Si—C. D50 of the second active material may be, for example, 1 to 10 μm. In the entire negative electrode active material layer 20, the ratio of the mass of the second active material to the total mass of the first active material and the second active material may be, for example, 0.01 to 0.20, 0.01 to 0.10, 0.01 to 0.05, or 0.01 to 0.03. The negative electrode active material layer 20 may contain three or more kinds and four or more kinds of active materials as long as they contain two or more kinds of active materials having different specific capacities.

The negative electrode active material layer 20 may further include a conductive material and a binder. The blending amount of the conductive material may be, for example, 0.1 to 10 parts by mass with respect to 100 parts by mass of the negative electrode active material. The conductive material may include, for example, at least one selected from the group consisting of acetylene black (AB), Ketjen black (registered trademark, KB), vapor-grown carbon fiber (VGCF), carbon nanotubes (CNT), and graphene flakes (GF). The blending amount of the binder may be, for example, 0.1 to 10 parts by mass with respect to 100 parts by mass of the negative electrode active material. The binder may include, for example, at least one selected from the group consisting of carboxymethyl cellulose (CMC), styrene-butadiene rubber (SBR), polyacrylic acid (PAA), polyimide, polytetrafluoroethylene (PTFE), and polyvinylidene fluoride (PVdF). The same applies to the positive electrode active material layer 10 described later with respect to the type and the blending amount of the conductive material and the binder.

The second region 22 has a composition different from that of the first region 21. following formula (2) is satisfied.

$$R 1 < R 2 \qquad ( 2 )$$

R1: in the first region 21, the ratio of the mass of the second active material to the total mass of the first active material and the second active material
R2: The ratio of the mass of the second active material to the total mass of the first active material and the second active material in the second region 22

The mass ratio (R1) may be, for example, 0 or more, 0.01 or more, 0.03 or more, or 0.05 or more. R1 may be, for example, less than or equal to 0.10, less than or equal to 0.075, or less than or equal to 0.05. The mass ratio (R2) may be, for example, more than 0, 0.05 or more, 0.10 or more, 0.15 or more, 0.20 or more, 0.25 or more, 0.30 or more, 0.35 or more, 0.40 or more, 0.45 or more, 0.50 or more, 0.55 or more, 0.6 or more, 0.7 or more, 0.8 or more, or 0.9 or more. R2 may be, for example, 1 or less, 0.95 or less, 0.90 or less, 0.80 or less, 0.70 or less, or 0.60 or less.

The acceptance capacity (unit: mAh/cm²) per unit area in the respective regions is determined from the basis weight (unit: mg/cm²), the blending ratio (mass ratio) of the active material, and the specific capacity (unit: mAh/g) of the active material. The acceptance capacity per unit area between the first region 21 and the second region 22 may be approximate. For example, following formula (7) may be satisfied.

$$0.8 \leq C 2 / C 1 \leq 1.2 \qquad ( 7 )$$

C1: Acceptance capacity per unit area in the first region 21
C2: Acceptance capacity per unit area in the second region 22
   As the capacitance ratio (C2/C1) approximates to 1, it is expected that the unevenness of the electrode-reaction decreases in the in-plane direction. The capacitance ratio (C2/C1) may be, for example, 0.85 or more, 0.90 or more, 0.95 or more, or 0.99 or more. C2/C1 may be, for example, 1.15 or less, 1.10 or less, 1.05 or less, or 1.01 or less.

### Positive Electrode Active Material Layer

In plan view, the positive electrode active material layer 10 may have a smaller area than the negative electrode active material layer 20. The ratio (Sn/Sp) of the area (Sn) of the negative electrode active material layer 20 to the area (Sp) of the positive electrode active material layer 10 may be, for example, 1.01 to 1.1. The positive electrode active material layer 10 may be entirely flat. Since the positive electrode active material layer 10 does not have a groove, an increase in design capacity is expected. Note that “flat” means that the ratio of the minimum thickness (Tmin) of the layer to the maximum thickness (Tmax) of the layer is 0.8 to 1 (or 0.9 to 1).

The positive electrode active material layer 10 may be supported by the positive electrode current collector 14, for example. The positive electrode current collector 14 may include, for example, aluminum (Al), a conductive resin, or the like. The positive electrode current collector may include, for example, an Al foil or an Al alloy foil. The thickness of the positive electrode current collector 14 may be, for example, 5 to 50 μm. A conductive layer may be interposed between the positive electrode current collector 14 and the positive electrode active material layer 10. The thickness of the positive electrode active material layer 10 may be, for example, 10 to 1000 μm, 50 to 500 μm, or 100 to 300 μm.

The positive electrode active material layer 10 includes a positive electrode active material. Examples of the positive electrode active material may include at least one selected from the group consisting of LiCoO₂, LiNiO₂, LiMnO₂, LiMn₂O₄, Li(NiCoMn)O₂, Li(NiCoAl)O₂, LiFePO₄. For example, “(NiCoMn)” in “Li(NiCoMn)O₂” indicates that the sum of the compositional ratios in parentheses is 1. As long as the sum is 1, the amounts of the individual components are optional. Li(NiCoMn)O₂ may include, for example, LiNi_{0.8}Co_{0.1}Mn_{0.1}O₂. D50 of the positive electrode active material may be, for example, 5 to m. The positive electrode active material layer 10 may further include the above-described conductive material and binder.

### Separator

The power storage element 50 may further include a separator (not shown). The separator is disposed between the positive electrode active material layer 10 and the negative electrode active material layer 20. The separator is electrically insulating. The separator may include, for example, a porous film made of polyolefin. The separator may include, for example, at least one selected from the group consisting of polyethylene (PE) and polypropylene (PP). The thickness of the separator may be, for example, 5 to 50 μm, or 10 to 30 μm. The porosity of the separator may be, for example, 50 to 60%.

### Electrolytic Solution

The electrolytic solution includes Li and solvents. Li content may be, for example, from 0.5 to 2 mol/kg. Li salt may comprise at least one selected from the group consisting of LiPF₆, LiBF₄, and Li(FSO₂)₂N. The solvents may include at least one selected from the group consisting of ethylene carbonate (EC), fluoroethylene carbonate (FEC), propylene carbonate (PC), ethyl methyl carbonate (EMC), dimethyl carbonate (DMC), and diethyl carbonate (DEC). The electrolytic solution may further contain an optional additive. No. 1

A positive electrode paste was formed by mixing a positive electrode active material (LiNi_{0.8}Co_{0.1}Mn_{0.1}O₂, D50: 10 μm), a conductive material (AB), a binder (PVdF), and a dispersing medium (N-methyl-2-pyrrolidone). The solids formulation was “LiNi_{0.8}Co_{0.1}Mn_{0.1}O₂:AB:PVdF=93:4:3 (by mass)”. The solids concentration was 65% (mass fraction). A coating film was formed by coating a positive electrode paste on one surface of a positive electrode current collector (Al foil, thickness: 30 μm) with a comma coater. The coating film was dried in a drying furnace to form a positive electrode active material layer. The drying temperature was 120° C. The drying time was 10 minutes. After being dried, the basis weight of the positive electrode active material layers was 35 mg/cm². The positive electrode active material layer was compressed by a roll press machine, whereby a positive electrode original fabric was produced. After compaction, the positive electrode active material layers had a 2.9 g/cm³. The positive electrode original material was cut to produce a positive electrode. The planar dimensions of the positive electrode were 24.5 cm×14.5 cm. By ultrasonic welding, a current collector tub (Al piece, width: 5 mm, thickness: 150 μm) was bonded to the back surface of the positive electrode current collector.

The planetary mixer mixed the first active material (spherical natural graphite, D50: 17 μm), the thickener (CMC), the binder (SBR), and the dispersing medium (water) for 20 minutes to form the first paste. The composition of the first paste was “graphite:CMC:SBR:water=98:1:1:85 (by mass)”. The first paste was striped on one side of the negative electrode current collector (Cu foil, thickness: 15 μm, width: 25 cm) by a slit die coater. The coating width (width of the first region) was 10 mm. The blanking width (width of the second region) was 2 mm. A first region (width: 10 mm) was formed by drying the first paste. The basis weight of the first region was 21.6 mg/cm². The first region was compressed by a roll press. After compressing, the density of the first region was 1.5 g/cm³.

The second active material (SiO, D50: 6 μm), the conductive material (KB), the binder (PAA), and the dispersing medium (water) were mixed by the planetary mixer for 20 minutes to form a second paste. The formulation of the second pastes was “SiO:KB:PAA:water=93:5:2:90 by weight”. A second paste was striped on the respective blanks (2 mm) between the first region and the first region by means of a slit die coater. A second region (width: 2 mm) was formed by drying the second paste. The basis weight of the second region was 3.6 mg/cm². As described above, the negative electrode original material was formed. A negative electrode was produced by cutting the negative electrode raw material. The planar dimensions of the negative electrode were 25 cm×15 cm. A current collector (a Ni piece, a 5 mm, and a thickness of 50 μm) was bonded to the back surface of the negative electrode current collector by resistance-welding.

A positive electrode, a separator, and a negative electrode were laminated so that the positive electrode and the negative electrode were opposed to each other with the separator (PE porous film, porosity: 55%, thickness: 20 μm, plane size: 25.5 cm×15.5 cm) interposed therebetween, thereby forming a power storage element. The power storage element had a monopolar structure. 10 g electrolytic solution [LiPF₆ (1 mol/kg), EC:FEC:EMC:DMC=2:1:3:4 (volume)], and the power storage element were housed in an outer casing (a pouch made of Al laminated film). By vacuum-sealing the outer casing, No. 1 laminated cell was made. Hereinafter, the laminated cell may be abbreviated as a “cell”. No. 2 to No. 11

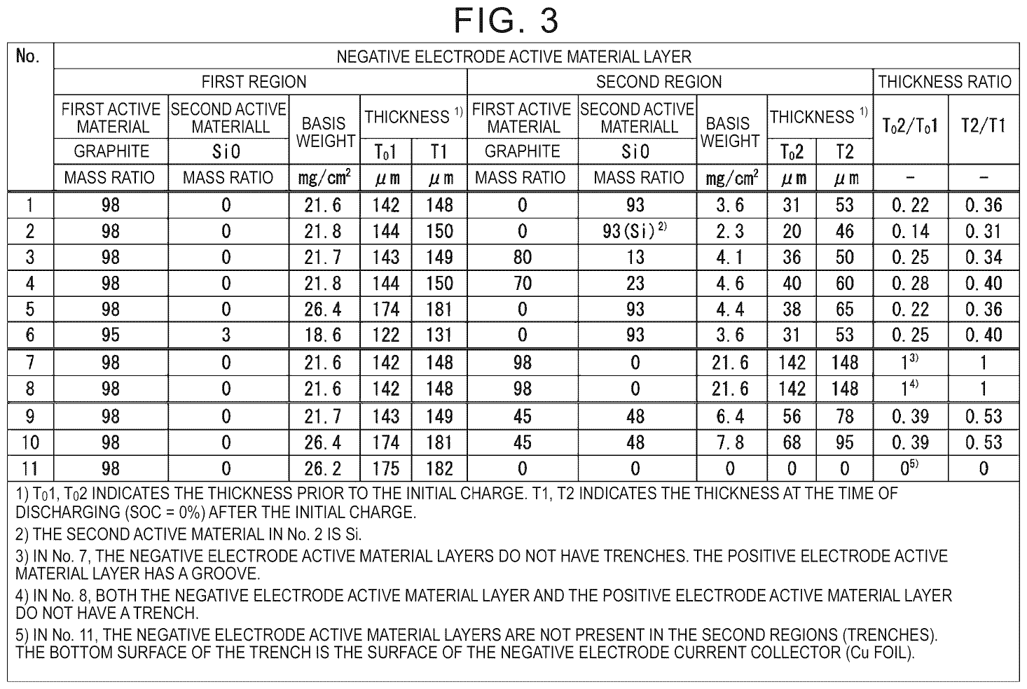

FIG. 3 is a table showing experimental conditions. Cell of No. 2 cell was made in the same way as No. 1, except that Si (D50: 2 μm) was used as the second active material instead of SiO, and the basis weight and thickness of each region were changed.

Cells of No. 3, No. 4, and No. 9 were made in the same manner as No. 1, except that the mass ratio, the basis weight, and the thickness of the first active material and the second active material in the second region were changed.

Cells of No. 5 and No. 10 were made in the same way as No. 1, except that the basis weight of the positive electrode active material layer is changed to a 43 mg/cm², and the mass ratio, the basis weight, and the thickness of the first active material and the second active material in the second region were also changed.

When the positive electrode paste was applied in a stripe shape, a groove was applied to the positive electrode active material layer. The coating width of the positive electrode active material layers was 10 mm, and the blanking width was 2 mm. The negative electrode active material layer was formed by coating the first paste on the entire surface of the negative electrode current collector. The negative electrode active material layer does not have a groove. Except for these, cell of No. 7 was fabricated in the same way as No. 1.

The positive electrode active material layer and the negative electrode active material layer were each formed with no grooves. Except for this, cell of No. 8 was made in the same way as No. 1.

The second paste was not applied to the second region, and the power storage element was formed while the second region remained blank. In the first region, the basis weight of the first region was increased compared to No. 1 so that all Li from the positive electrode can be received. Except for these, cell of No. 11 was fabricated in the same way as No. 1.

### Evaluation

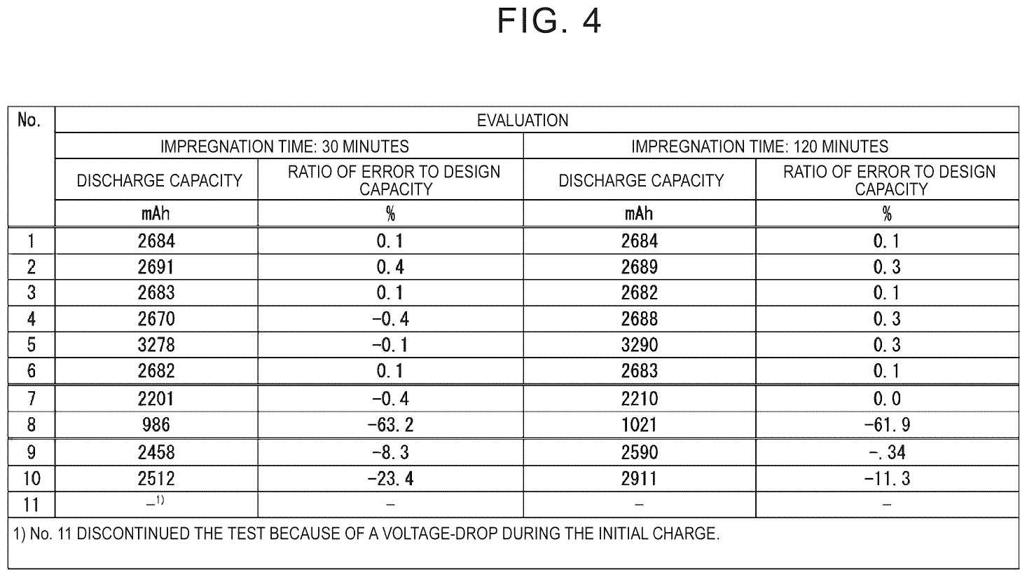

By sandwiching the cell between the two Al plates, a restraining pressure of 0.3 mPa or more was applied to the cell. In a state in which a restraining pressure was applied to the cell, the initial charging and discharging under the following conditions were performed.
CCCV Charge: CC Current: 300 mA, CV Voltage: 4.2 V, Cut Current: 10 mA
CCCV Discharge: CC Current: 300 mA, CV Voltage: 2.5 V, Cut Current: 10 mA
   FIG. 4 is a table showing experimental results. The impregnation time indicates the time from the injection of the electrolytic solution to the start of the initial charging. In each sample, the initial discharge capacity was measured at both a 30-minute impregnation time and a 120-minute impregnation time.

### Results

In No. 8, the actual discharge capacity was significantly reduced compared to the design capacity. In No. 8, both the positive electrode active material layer and the negative electrode active material layer do not have grooves. It is considered that the impregnation of the electrolytic solution is insufficient.

No. 7 showed a higher discharge capacity than No. 8. It is considered that the formation of the groove in the positive electrode active material layer promotes the impregnation of the electrolytic solution. However, since the positive electrode active material layer was reduced with the formation of the groove, the design capacity was lowered.

In No. 1 to No. 6, No. 9, and No. 10, grooves (second region) were provided in the negative electrode active material layer. In these samples, a discharge capacity close to the designed capacity was obtained. It is considered that the impregnation of the electrolytic solution was accelerated by the groove.

Comparison within No. 1 to No. 6, No. 9, and No. 10 shows that the smaller the thickness ratio (T₀2/T₀1, T2/T1) is, the more likely the effect of promoting the impregnation is.

It is considered that No. 5 and No. 8 are more difficult to impregnate because the positive electrode active material layer has a higher density than the other samples. In No. 5, it is considered that the impregnation of the electrolytic solution is completed in a short time by providing a groove in the negative electrode active material layer.

In No. 6, the first region includes both the first active material (graphite) and the second active material (SiO). Even if the second active material is included in the first region, it is considered that the impregnation of the electrolytic solution can be accelerated as long as there is a difference in thickness between the first region and the second region.

In No. 11, the test was stopped because a voltage drop occurred during charging. After discontinuation of the study, the cells were dismantled. Li deposition was observed at the border between the negative electrode active material layers and the trenches (blanks). It is considered that Li deposition caused a voltage-drop.

What is claimed is:

1. A lithium ion battery comprising:
a positive electrode active material layer;
a negative electrode active material layer; and
an electrolytic solution, wherein
the negative electrode active material layer includes a first region and a second region,
the first region and the second region are arranged alternately in a direction orthogonal to a thickness direction of the negative electrode active material layer,
the negative electrode active material layer contains a first active material and a second active material,
the second active material has a larger specific capacity than the first active material, and
relationships of following formula (1) and formula (2) are met:
$$T 2 < T 1 \qquad ( 1 )$$
$$R 1 < R 2 \qquad ( 2 )$$
in the formula (1),
T1 indicates a thickness of the first region during discharging, and
T2 indicates a thickness of the second region during discharging, and
in the formula (2),
R1 indicates a ratio of a mass of the second active material to a total mass of the first active material and the second active material in the first region, and
R2 indicates a ratio of a mass of the second active material to a total mass of the first active material and the second active material in the second region.

2. The lithium ion battery according to claim 1, wherein at least one of relationships of following formula (3) and formula (4) is further met:
$$4 T 2 / T 1 \leq 0.4 \qquad ( 3 )$$
$${T}_{0} 2 / {T}_{0} 1 \leq 0.3 \qquad ( 4 )$$
in the formula (4),
T₀1 indicates a thickness of the first region before initial charging, and
T₀2 indicates a thickness of the second region before initial charging.

3. The lithium ion battery according to claim 2, wherein at least one of relationships of following formula (5) and formula (6) is further met:
$$130 μm \leq T 1 \qquad ( 5 )$$
$$100 μm \leq {T}_{0} 1. \qquad ( 6 )$$

4. The lithium ion battery according to claim 1, wherein:
the first active material contains graphite; and
the second active material contains at least one kind selected from the group consisting of silicon, silicon oxide, and a silicon-carbon composite material.

5. A lithium ion battery comprising:
a positive electrode active material layer;
a negative electrode active material layer; and
an electrolytic solution, wherein
the negative electrode active material layer includes a first region and a second region,
the first region and the second region are arranged alternately in a direction orthogonal to a thickness direction of the negative electrode active material layer,
the negative electrode active material layer contains a first active material and a second active material,
the second active material has a larger specific capacity than the first active material,
the first active material contains graphite,
the second active material contains at least one kind selected from the group consisting of silicon, silicon oxide, and a silicon-carbon composite material,
relationships of following formula (1) and formula (2) are met:
$$T 2 < T 1 \qquad ( 1 )$$
$$R 1 < R 2 \qquad ( 2 )$$
in the formula (1),
T1 indicates a thickness of the first region during discharging, and
T2 indicates a thickness of the second region during discharging, and
in the formula (2),
R1 indicates a ratio of a mass of the second active material to a total mass of the first active material and the second active material in the first region, and
R2 indicates a ratio of a mass of the second active material to a total mass of the first active material and the second active material in the second region, and
at least one of relationships of following formula (3) and formula (4) is met, and at least one of relationships of following formula (5) and formula (6) is met:
$$T 2 / T 1 \leq 0.4 \qquad ( 3 )$$
$${T}_{0} 2 / {T}_{0} 1 \leq 0.3 \qquad ( 4 )$$
$$130 μm \leq T 1 \qquad ( 5 )$$
$$100 μm \leq {T}_{0} 1 \qquad ( 6 )$$
in the formula (4) and the formula (6),
T₀1 indicates a thickness of the first region before initial charging, and
T₀2 indicates a thickness of the second region before initial charging.
